(19) United States
(12) Patent Application Publication
(10) Pub. No.: US 2023/0064510 A1
(43) Pub. Date: Mar. 2, 2023

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Hiroki TSUJINAKA, Kanagawa (JP)

(73) Assignee: FUJIFILM Business Innovation Corp., Tokyo (JP)

(21) Appl. No.: 17/579,523

(22) Filed: Jan. 19, 2022

(30) Foreign Application Priority Data
Sep. 2, 2021 (JP) 2021-143321

(51) Int. Cl. H04L 9/40

(52) U.S. Cl. CPC H04L 63/107; H04L 63/102

(57) ABSTRACT

An information processing apparatus includes a processor configured to: in a case where a managed terminal being used by a managed user who is not permitted to log into a network system has been logged in the network system under management by a managing user who is permitted to log into the network system, specify a managed terminal to be logged out from among managed terminals being used by managed users under management by the managing user, in accordance with a predetermined operation performed by the managing user; and cause the specified managed terminal to be logged out of the network system.

### CROSS-REFERENCE TO RELATED APPLICATIONS

This application is based on and claims priority under 35 USC 119 from Japanese Patent Application No. 2021-143321 filed Sep. 2, 2021.

### BACKGROUND

### (i) Technical Field

The present disclosure relates to an information processing apparatus, an information processing method, and a non-transitory computer readable medium.

### (ii) Related Art

In recent years, the number of cases where a big company collaborates with a start-up company or a freelancer to conduct business has been increasing. In terms of work efficiency, in some cases it may be desirable that an engineer from a start-up company or the like collaborating with a big company visit the big company and connect a terminal device carried with him/her to an internal system of the big company through a network so that a collaborative work may be done as a team.

Meanwhile, security in companies has been tending to increase, and system environment is often such that an outsider who is outside a company is not able to easily log into a network system of the company.

Assuming the company's network system environment mentioned above, in the case where a system administrator of a company wants to allow an outsider, that is, a user who is not permitted to log into the network system, to log into and participate in the network system, the system administrator may think that the outsider may be allowed to participate in the network system on the condition that, for example, an employee of the company who performs a collaborative work with the outsider participates in the network together with the outsider and serves as a managing user who constantly monitors the outsider while participating in the network system.

For example, Japanese Unexamined Patent Application Publication No. 2015-062139 discloses an example of the related art.

### SUMMARY

However, in the situation in which a managed user has been logged in a network system under management by a managing user, there arises a problem in terms of the security in the case where the managed user is kept logged in the network system even after the managed user has become out of control by the managing user when, for example, the managing user leaves the network system.

Aspects of non-limiting embodiments of the present disclosure relate to, in a case where a managed user who is not permitted to log into a network system has been logged in the network system under management by a managing user who is permitted to log into the network system, when the managed user has become out of control by the managing user, preventing a situation in which the managed user is not managed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: in a case where a managed terminal being used by a managed user who is not permitted to log into a network system has been logged in the network system under management by a managing user who is permitted to log into the network system, specify a managed terminal to be logged out from among managed terminals being used by managed users under management by the managing user, in accordance with a predetermined operation performed by the managing user; and cause the specified managed terminal to be logged out of the network system.

### BRIEF DESCRIPTION OF THE DRAWINGS

Exemplary embodiments of the present disclosure will be described in detail based on the following figures, wherein:

FIG. 1 is a block configuration diagram of a network system in a first exemplary embodiment;

FIG. 2 is a diagram illustrating an example of a connected terminal table in the first exemplary embodiment;

FIG. 3 is a diagram illustrating an example of an access point management table in the first exemplary embodiment;

FIG. 4 is a sequence diagram illustrating a log-out process in the first exemplary embodiment;

FIG. 5 is a block configuration diagram of a network system in a second exemplary embodiment;

FIG. 6 is a diagram illustrating an example of a beacon management table in the second exemplary embodiment;

FIG. 7 is a diagram illustrating an example of a room information table in the second exemplary embodiment;

FIG. 8 is a sequence diagram illustrating a log-out process in the second exemplary embodiment;

FIG. 9 is a block configuration diagram illustrating an authentication system in third and fourth exemplary embodiments;

FIG. 10 is a sequence diagram illustrating a log-out process in the third exemplary embodiment;

FIG. 11 is a sequence diagram illustrating a log-out process in the fourth exemplary embodiment;

FIG. 12 is a block configuration diagram illustrating an authentication system in a fifth exemplary embodiment; and

FIG. 13 is a sequence diagram illustrating a log-out process in the fifth exemplary embodiment.

### DETAILED DESCRIPTION

Hereinafter, exemplary embodiments of the present disclosure will be described with reference to drawings.

### First Exemplary Embodiment

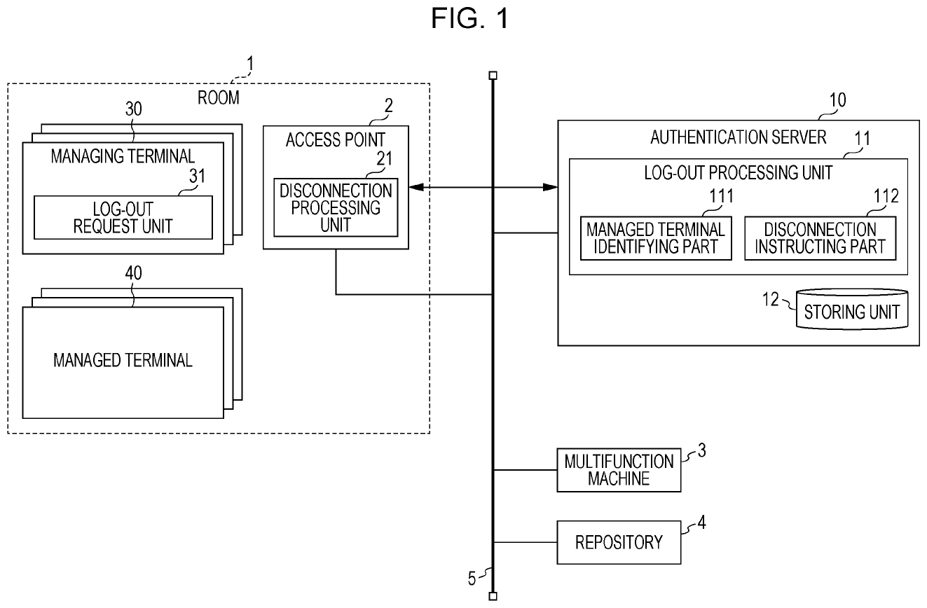

FIG. 1 is a block configuration diagram illustrating an authentication system in a first exemplary embodiment. The authentication system in the first exemplary embodiment is incorporated into a local area network (LAN) system established in a company (hereinafter, referred to as an “internal system”) and performs user authentication of a user who wants to participate in the internal system through a network. The authentication system in the first exemplary embodiment also performs a process for logging the user into and out of the internal system.

The internal system in the first exemplary embodiment includes, as illustrated in FIG. 1, an access point 2 that is installed in a room 1 of a company, a multifunction machine 3 and a repository 4 that are used by a user of the internal system, and an authentication server 10. The access point 2, the multifunction machine 3, the repository 4, and the authentication server 10 are connected to a LAN 5. In FIG. 1, the multifunction machine 3 and the repository 4 are illustrated as examples of devices that the user of the internal system uses. However, this configuration is merely an example, and the number and types of devices are not limited to the example of the system configuration illustrated in FIG. 1.

The room 1 illustrated in FIG. 1 is a specific space where a user who is permitted to log into the internal system is allowed to be present. That is, the room 1 is a high security space in a facility, and not everyone is allowed to access the space. As described above, the room 1 is a specific space where only a user who is permitted to log into the internal system is allowed to be present. In other words, only a trustworthy person is able to access the room 1.

However, under management by an employee or the like of the company who performs a collaborative work, a person who is not permitted to log into the internal system, for example, an outsider, may be permitted to enter the room 1 and log into the internal system and may actually log into the internal system.

The above-mentioned employee or the like of a company who performs a collaborative work will be referred to as a “managing user” who manages an outsider. Meanwhile, the outsider who is not permitted to log into the internal system but has been logged in the internal system under management by the employee or the like of the company who performs the collaborative work will be referred to as a “managed user” in the first exemplary embodiment. Strictly speaking, a user who is not permitted to log into the internal system is a user who is not trustworthy and is not able to log into the internal system because, for example, his/her personal information is not registered to the internal system. Thus, not only an outsider but an employee who belongs to a different business site of the same company may also be a “managed user”. Meanwhile, a user who is permitted to log into the internal system is a trustworthy user who may serve as a manager of a managed user and thus will be referred to as a “managing user” as described above.

Terms “logging in” and “logging out” used in the first exemplary embodiment will be explained.

In general, “logging in” is defined as connecting a computer to a network, allowing a user to use a service, and the like. “Logging in” in the first exemplary embodiment represents participating in an internal system through a network and is different from typical log-in to a computer by specifying a user ID and a password. “Being permitted to log into an internal system” or “being not permitted to log into an internal system” described above represents being or being not able to be connected to the internal system or being or being not permitted to participate in a network system of a company. Furthermore, “being logged into an internal system” in the first exemplary embodiment represents participating in the internal system through a network, more specifically, being connected to the access point 2 or the internal system. With the configuration of the internal system in the first exemplary embodiment, terminals 30 and 40 are connected to the internal system via the access point 2. Thus, “being logged into an internal system” is equivalent to being connected to the access point 2.

“Logging out” represents ending participation in a network, in other words, ending connection to an internal system. With the configuration of the internal system in the first exemplary embodiment, the terminals 30 and 40 are connected to the internal system via the access point 2. Thus, a state in which the terminals 30 and 40 are “logged out of the internal system” is equivalent to a state in which the terminals 30 and 40 are disconnected from the connected access point 2.

The terminals 30 and 40 are present in the room 1. The terminal 30 is a terminal device that a managing user uses (hereinafter, the terminal 30 will be referred to as a managing terminal 30). The terminal 40 is a terminal device that a managed user uses (hereinafter, the terminal 40 will be referred to as a managed terminal 40).

For convenience of explanation, a managing user carries a managing terminal 30 with him/her in the room 1. Thus, the managing user and the managing terminal 30 are in a one-to-one relationship, and the managed user and the managing terminal 30 are located at the same location in the room 1. The same applies to a managed user who is monitored, and the managed user carries a managed terminal 40 with him/her. Thus, the managed user and the managed terminal 40 are in a one-to-one relationship, and the managed user and the managed terminal 40 are located at the same location in the room 1. Furthermore, although, strictly speaking, the managing user monitors and manages the managed user, an explanation may be provided, from the viewpoint of the network system, such that the managing terminal 30 monitors and manages the managed terminal 40, based on the relationship between users and terminals.

Furthermore, based on the definition provided above, “logging out” represents disconnecting the managing terminal 30 and the managed terminal 40 from the access point 2. However, in the description provided below, for convenience of explanation, “logging out” may represent logging a user out, for example, logging a managing user or a managed user out, because “logging out” is performed in accordance with an instruction from a managing user. For example, logging a managed user out is equivalent logging the managed terminal 40 that the managed user is using out by disconnecting the managed terminal 40 from the access point 2.

The managing terminal 30 and the managed terminal 40 are terminal devices that are brought into the room 1 by users. Thus, the managing terminal 30 and the managed terminal 40 are portable information processing devices. The managing terminal 30 and the managed terminal 40 are, for example, mobile personal computers (PCs), tablet terminals, or smartphones. The managing terminal 30 and the managed terminal 40 each include a central processing unit (CPU), a read only memory (ROM), a random access memory (RAM), a storage as memory means, a short-range wireless communication interface and a mobile communication interface such as Wi-Fi® and Bluetooth® low energy (BLE) as communication means, and a user interface including a touch panel or a mouse, keyboard, and a display.

The managing terminal 30 in the first exemplary embodiment includes a log-out request unit 31. The log-out request unit 31 requests the authentication server 10 to log the managing terminal 30 out. The log-out request unit 31 is implemented by a collaborative operation of a computer forming the managing terminal 30 and a program executed by the CPU of the computer.

The access point 2 is a relay device that performs wireless communication with communication devices located in the room 1, that is, the managing terminal 30 and the managed terminal 40, and relays data communication performed between the internal system and the communication devices such as the managing terminal 30 and the managed terminal 40. Presence of a communication device in the room 1 is proved when the communication device communicates with the access point 2 installed in the room 1.

The authentication server 10 corresponds to an information processing apparatus according to an exemplary embodiment of the present disclosure. The authentication server 10 is a principal part of the authentication system in the first exemplary embodiment and performs authentication of a user who is using a terminal from which a long-in request has been transmitted. The authentication server 10 logs the managing terminal 30 and the managed terminal 40 as log-out targets out in response to a log-out request from the managing terminal 30. The authentication server 10 may be implemented with a hardware configuration of an existing general-purpose server computer. That is, the authentication server 10 includes a CPU, a ROM, a RAM, a hard disk drive (HDD) as memory means and a network interface provided as communication means. Furthermore, if necessary, the authentication server 10 may include a user interface including input means such as a mouse and a keyboard and display means such as a display.

The authentication server 10 includes a log-out processing unit 11 and a storing unit 12. In FIG. 1, components that will not be mentioned in the description of the first exemplary embodiment are omitted. For example, the first exemplary embodiment is characterized by log-out processing. Thus, components regarding user authentication processing or log-in processing are not illustrated in FIG. 1.

A managed terminal identifying part 111 identifies the managed terminal 40 to be logged out in accordance with a log-out request from the managing terminal 30. A disconnection instructing part 112 instructs the access point 2 to disconnect the managing terminal 30 and the managed terminal 40 to be logged out.

Various types of information that may be expressed in a table format as described below are stored in the storing unit 12. In the first exemplary embodiment, various types of information are stored in various tables such as a connected terminal table and an access point management table.

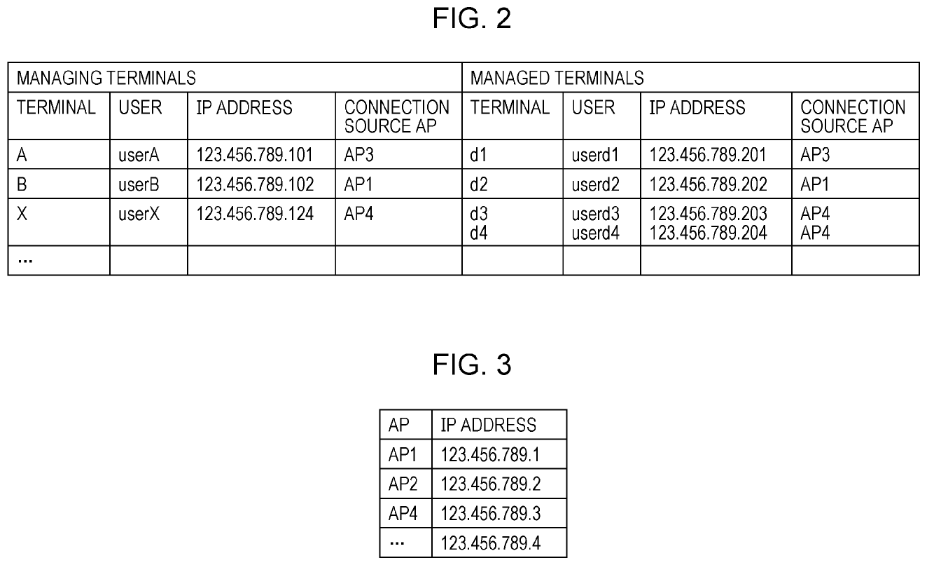

FIG. 2 is a diagram illustrating an example of a connected terminal table in the first exemplary embodiment. Managing terminals 30 connected to the internal system are registered in the connected terminal table. A managing terminal and a managed terminal that is being connected to the internal system under management by a managing user of the managing terminal are set in association with each other in the connected terminal table. As information on a managing terminal, a terminal, a user, an internet protocol (IP) address, and a connection source access point (AP) are set in association with one another. As information on a terminal, a terminal ID is set as identification information about the managing terminal 30 that is being connected to the internal system. As information on a user, a user ID is set as identification information about a managing user who is using the managing terminal 30. As an IP address, an IP address allocated to the managing terminal 30 is set. As information on a connection source AP, an access point ID is set as identification information about the access point 2 to which the managing terminal 30 is being wirelessly connected. As information on a managed terminal, a terminal, a user, an IP address, and a connection source AP are set in association with one another. As information on a terminal, a terminal ID is set as identification information about the managed terminal 40 that is being connected to the internal system. As information on a user, a user ID is set as identification information about a managed user who is using the managed terminal 40. As an IP address, an IP address allocated to the managed terminal 40 is set. As information on a connection source AP, an access point ID is set as identification information about the access point 2 to which the managed terminal 40 is being wirelessly connected. The connection source AP of a managed user may be omitted because the managed user and the managing user move together and stay in the same room 1, that is, the connection source AP of the managing terminal and the connection source AP of the managed terminal are the same. However, exceptionally, for example, multiple access points 2 may be installed in the same room 1. Thus, the connection source AP of a managing terminal and the connection source AP of a managed terminal are individually stored in the connected terminal table. As illustrated in FIG. 2, like a managing terminal “X”, some managing users may manage multiple managed users.

FIG. 3 is a diagram illustrating an example of an access point management table in the first exemplary embodiment. Management information on access points 2 included in the internal system is set in the access point management table. As the management information on each of the access points 2, an AP and an IP address are set in association with each other. As information on an AP, an access point ID is set as identification information about the access point 2. An IP address, which is address information unique to the access point 2, is set as an IP address.

The log-out processing unit 11 is implemented by a collaborative operation of a computer forming the authentication server 10 and a program executed by the CPU of the computer. The storing unit 12 is implemented by an HDD mounted in the authentication server 10. Alternatively, a RAM or memory means included in the internal system may be used via the LAN 5.

Furthermore, a program used in the first exemplary embodiment may be provided by communication means or may be stored in a computer-readable recording medium such as a compact disc-read only memory (CD-ROM) or a universal serial bus (USB) memory and provided. Programs provided by the communication means or the recording medium are installed into a computer, and when the programs are sequentially executed by the CPU of the computer, various processes are implemented.

Next, an operation in the first exemplary embodiment will be described. In the first exemplary embodiment, a managed user participates in a network of the internal system under management by a managing user. That is, the managed terminal 40 has been logged in the internal system. The same applies to other exemplary embodiments described later.

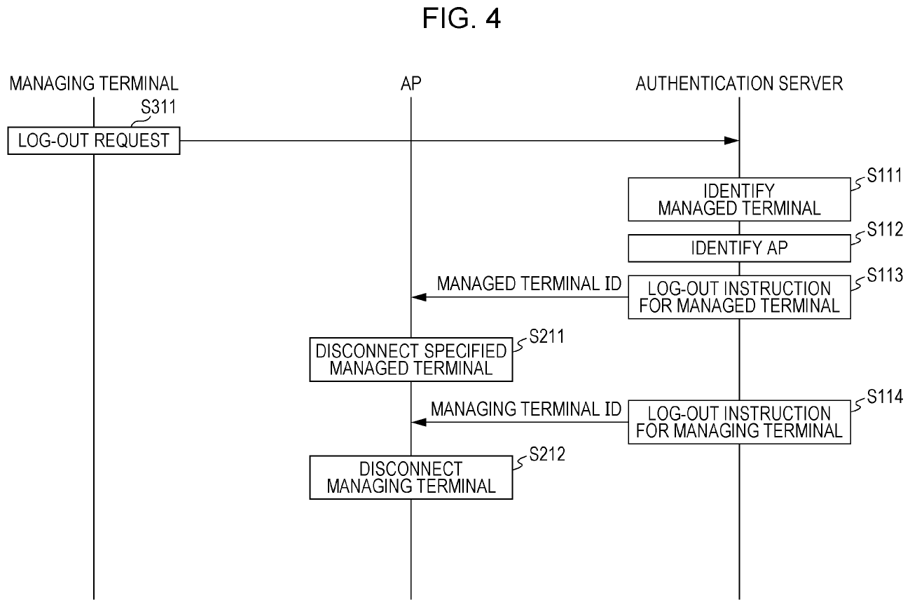

In the first exemplary embodiment, a process for the case where a managing user is logged out of the internal system will be described with reference to a sequence diagram illustrated in FIG. 4.

The log-out request unit 31 of the managing terminal 30 requests the authentication server 10 to log the managing terminal 30 out in accordance with a predetermined operation performed by a managing user (step S311). Although the access point 2 relays the log-out request from the managing terminal 30 to the authentication server 10, explanation for a relay function of the access point 2 will not be provided because the relay function is not a characteristic function. The relay function is also omitted in the sequence diagram of FIG. 4.

When receiving the log-out request, the managed terminal identifying part 111 of the authentication server 10 refers to the connected terminal table to identify a managed terminal 40 that is being managed by the managing terminal 30 that has transmitted the log-out request (step 111) and identify an access point 2 to which the identified managed terminal 40 is being connected (step 112). As is clear from the setting example of FIG. 2, a managing terminal 30 with a terminal ID “A” (hereinafter, referred to as a “managing terminal A”, the same applies to other devices) manages a managed terminal dl, and the managed terminal dl is being connected to an access point AP3.

In the above description, information for identifying a transmission source of the log-out request is not clearly indicated. The authentication server 10 may refer to header information about a data packet forming the log-out request to identify the managing terminal 30 that has transmitted the log-out request. Alternatively, the managing terminal 30 may add a terminal ID of the managing terminal 30 or a user ID of the managing user to the log-out request to be transmitted.

Then, the disconnection instructing part 112 instructs the access point AP3 to disconnect the connected managed terminal dl (step 113).

A disconnection processing unit 21 of the access point AP3 disconnects the specified managed terminal dl (step 211). Accordingly, the managed terminal dl is disconnected from the access point AP3 and is thus forcibly logged out of the internal system.

As described above, when the managed terminal dl being managed is logged out, the disconnection instructing part 112 instructs the access point AP3 to disconnect the managing terminal A in response to a request from the managing terminal A that has transmitted the log-out request (step 114). In response to the instruction, the disconnection processing unit 21 of the access point 2 disconnects the managing terminal A and thus logs the managing terminal A out (step 212).

According to the first exemplary embodiment, when the managing terminal 30 issues a log-out request, the managed terminal 40 that is being managed by the managing terminal 30 is forcibly logged out. Accordingly, before a managing user who is managing a managed user moves out of the network system, the managed user is caused to be logged out. Thus, a situation in which there is no managing user available to manage the managed user may be prevented.

### Second Exemplary Embodiment

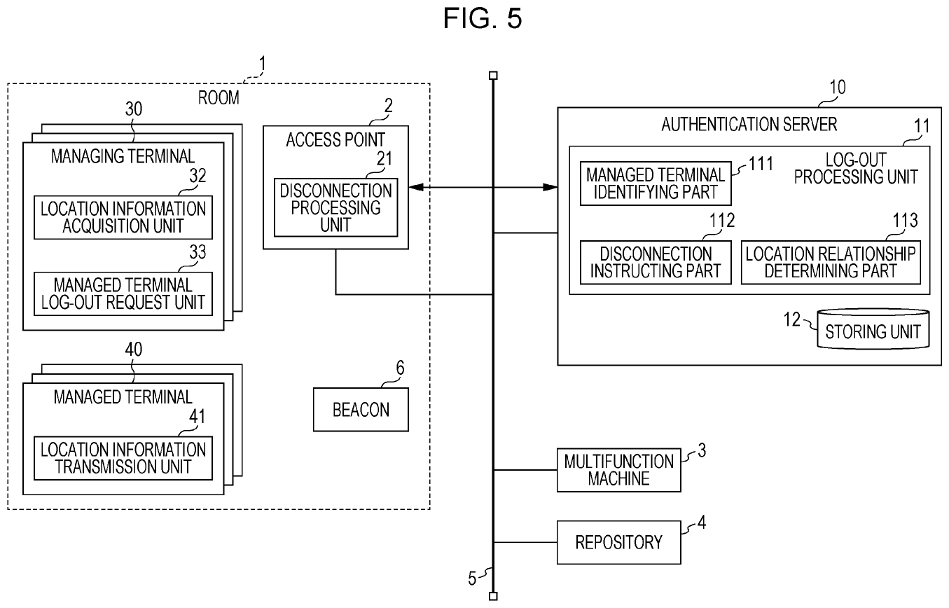

FIG. 5 is a block configuration diagram illustrating an authentication system in a second exemplary embodiment. The same components as those of the authentication system in the first exemplary embodiment illustrated in FIG. 1 are denoted by the same reference signs and explanation for those components will be omitted in an appropriate manner.

A beacon 6 is installed in the room 1 in the second exemplary embodiment. The beacon 6 is a transmitter that wirelessly transmits, using a low-power-consumption short-range wireless communication technique (for example, BLE), installation location information for identifying the location where the beacon 6 is installed.

The managing terminal 30 in the second exemplary embodiment does not include the log-out request unit 31 but includes a location information acquisition unit 32 and a managed terminal log-out request unit 33. The location information acquisition unit 32 acquires installation location information transmitted from the beacon 6. The managed terminal log-out request unit 33 requests the authentication server 10 to log the managed terminal 40 that is being managed by the managing terminal 30 out. The location information acquisition unit 32 and the managed terminal log-out request unit 33 of the managing terminal 30 are implemented by a collaborative operation of a computer forming the managing terminal 30 and a program executed by the CPU of the computer.

The managed terminal 40 in the second exemplary embodiment includes a location information transmission unit 41. In response to a request from the authentication server 10, the location information transmission unit 41 acquires installation location information transmitted from the beacon 6, and transmits the acquired installation location information to the authentication server 10 as location information indicating the current location of the managed terminal 40. The location information transmission unit 41 is implemented by a collaborative operation of a computer forming the managed terminal 40 and a program executed by the CPU of the computer.

The log-out processing unit 11 of the authentication server 10 includes a location relationship determining part 113, in addition to the configuration in the first exemplary embodiment. The location relationship determining part 113 determines the location relationship between the managing terminal 30 that has transmitted a log-out request and the managed terminal 40 of a managed user who is being managed by the managing user of the managing terminal 30. Specifically, the location relationship determining part 113 determines whether or not the managed terminal 40 is away from the managing terminal 30 by a predetermined distance or more.

Furthermore, a beacon management table and a room information table are also registered in the storing unit 12 in the second exemplary embodiment.

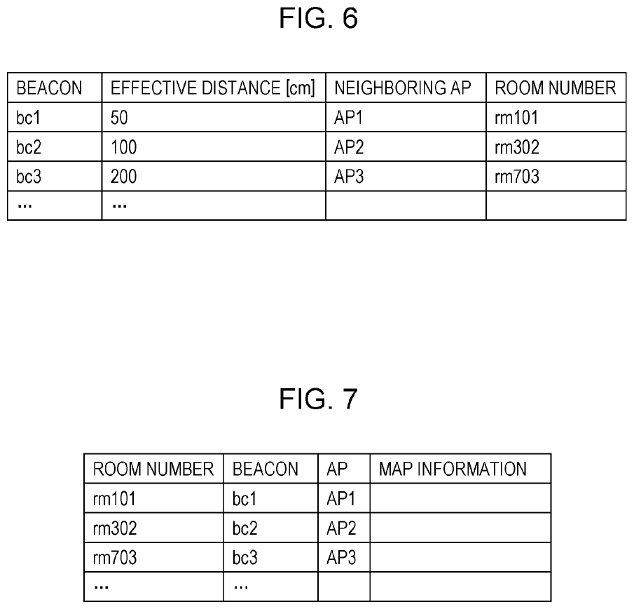

FIG. 6 is a diagram illustrating an example of a beacon management table in the second exemplary embodiment. Information for managing beacons 6 included in the internal system is set in the beacon management table. As the management information on each of the beacons 6 included in the internal system, a beacon, effective distance, a neighboring AP, and a room number are set in association with one another. As information on a beacon, a beacon ID is set as identification of the beacon 6. As information on effective distance, a distance defined as an effective range of wireless communication of the beacon 6 is set. At least one access point 2 and one beacon 6 are installed in the room 1. As information on a neighboring AP, an access point ID is set as identification information about the access point 2 closest to the beacon 6. A room number as information for identifying the room 1 in which the beacon 6 is installed is set as a room number.

FIG. 7 is a diagram illustrating an example of a room information table in the second exemplary embodiment. Information on rooms 1 in which access points 2 and beacons 6 are installed in the internal system is set in the room information table. As the room information on each of the rooms 1, a room number, a beacon, an AP, and map information are set in association with one another. A room number as information for identifying the room 1 is set as a room number. As information on a beacon, a beacon ID is set as identification information about the beacon 6 installed in the room 1. As information on an AP, an access point ID is set as identification information about the access point 2 installed in the room 1. As map information, space information indicating characteristics of the room 1 is set. The details of the map information will be described later.

As described above, a managing user needs to monitor a managed user at least while the managed user stays in the room 1 so that the managed user is not able to breach the security. In order for the managing user to monitor the managed user, it is desirable that the managed user be located near the managing user. In other words, if the managed user moves away from the managing user by a predetermined distance or more to a place where the managing user is not able to keep an eye on, the managing user may not be able to monitor the managed user. Thus, this situation needs to be avoided. The second exemplary embodiment is characterized by specifying a managed terminal 40 that is away from the managing terminal 30 by a predetermined distance or more as a log-out target.

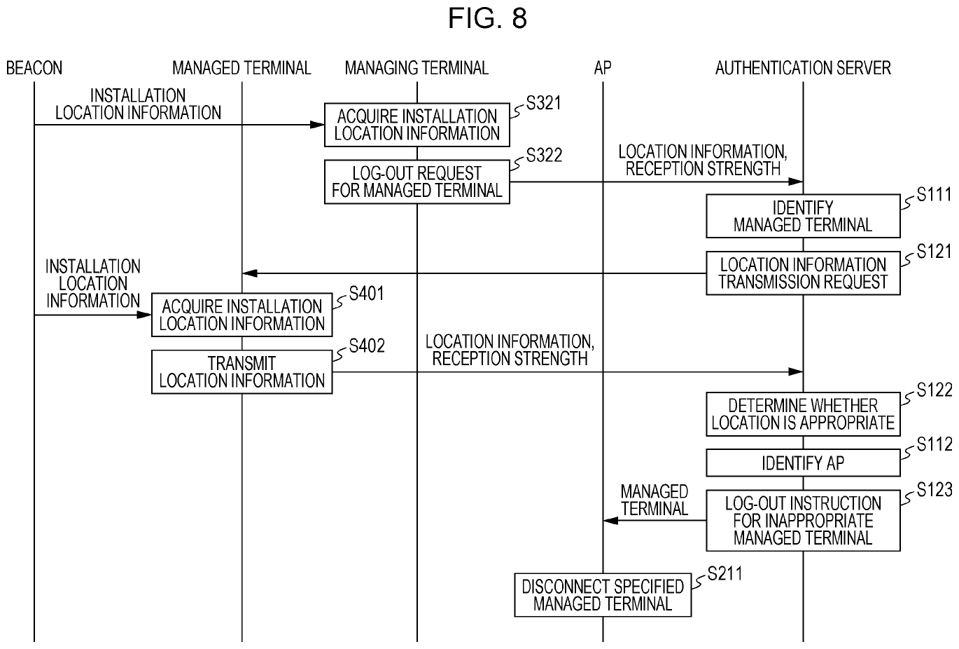

Next, a process for the case where a managing user causes the managed terminal 40 to be logged out of the internal system will be described with reference to a sequence diagram of FIG. 8. The same processing operations as those in the first exemplary embodiment will be denoted by the same step numbers and explanation for those processing operations will be omitted in an appropriate manner.

When a managing user of the managing terminal 30 performs a predetermined log-out request operation for the managed terminal 40, the location information acquisition unit 32 acquires installation location information transmitted from the beacon 6 (step 321). The installation location information contains a beacon ID. At this time, the location information acquisition unit 32 acquires the reception strength at the time of acquisition of the information. Then, the managed terminal log-out request unit 33 adds the reception strength to the installation location information acquired by the location information acquisition unit 32 as location information indicating the current location of the managing terminal 30, and requests the authentication server 10 to cause the managed terminal 40 that the managing terminal 30 is managing to be logged out (step 322).

When receiving the log-out request, the managed terminal identifying part 111 of the authentication server 10 refers to the connected terminal table to identify the managed terminal 40 that is being managed by the managing terminal 30 that has transmitted the log-out request (step 111). Then, the location relationship determining part 113 requests the identified managed terminal 40 to transmit the location information (step 121).

When the request to transmit location information is transmitted from the authentication server 10, the location information transmission unit 41 acquires the installation location information transmitted from the beacon 6 (step 401). At this time, the location information transmission unit 41 acquires the reception strength at the time of acquisition of the information. Then, the location information transmission unit 41 adds the reception strength to the acquired installation location information as location information indicating the current location of the managed terminal 40, and transmits the location information including the reception strength to the authentication server 10 (step 402).

When the location information is transmitted from the managed terminal 40 in response to the transmission request, the location relationship determining part 113 compares the location information acquired from the managing terminal 30 with the location information acquired from the managed terminal 40. In the case where the location information acquired from the managing terminal 30 and the location information acquired from the managed terminal 40 are the same, the location relationship determining part 113 determines that the managing user and the managed user are present in the same room 1, that is, the managing user and the managed user are located close to each other.

Furthermore, the location relationship determining part 113 may determine the location relationship between the managing user and the managed user in the room 1. For example, the location relationship determining part 113 refers to the beacon management table to acquire the effective distance of the beacon 6 on the basis of the acquired beacon ID. Then, the location relationship determining part 113 converts the reception strengths acquired from the managing terminal 30 and the managed terminal 40 into distances. The distances obtained by the conversion correspond to the straight-line distance from the beacon 6 to the managing terminal 30 and the straight-line distance from the beacon 6 to the managed terminal 40. In the case where the difference between the straight-line distances is less than or equal to a predetermined threshold, it is determined that the managing user and the managed user are close to each other. In the description provided above, the location relationship is determined based on the beacon IDs. However, it may be determined that the managing terminal 30 and the managed terminal 40 are present in the room 1 in which the beacon 6 is installed in the case where the converted distances are less than or equal to the effective distance.

When the distance between the beacon 6 and the managing terminal 30 and the distance between the beacon 6 and the managed terminal 40 are represented by d30 and d40, respectively, the managing terminal 30 and the managed terminal 40 may be logically far away from each other by at most d30+d40. However, the installation location of a beacon in the room 1 is fixed and known information. Thus, by referring to the installation location of the beacon 6 and setting a threshold used for comparison with a difference between the straight-line distances to a proper value, it may be possible to more correctly determine the location relationship between the managing terminal 30 and the managed terminal 40 in the room 1.

Then, the managed terminal identifying part 111 refers to the determination result of the location relationship between the managing terminal 30 and the managed terminal 40 obtained by the location relationship determining part 113 to identify the managed terminal 40 that is being used by the managed user determined to be away from the managing user by the predetermined distance or more, and refers to the connected terminal table to identify the access point 2 to which the identified managed terminal 40 is being connected (step 112). Then, the disconnection instructing part 112 instructs the identified access point 2 to disconnect the managed terminal 40 (step 123). A managed terminal 40 that is determined not to be away from the managing terminal 30 by the predetermined distance or more is not regarded as a log-out target.

The disconnection processing unit 21 of the access point 2 disconnects the specified managed terminal 40 (step 211). Accordingly, the disconnected managed terminal 40 is forcibly logged out of the internal system. In the second exemplary embodiment, the managing terminal 30 is not a log-out target.

According to the second exemplary embodiment, the managed user who is away from the managing user by the predetermined distance or more is presumed to be out of sight of the managing user and is not managed by the managing user. Thus, the managed terminal 40 is forcibly logged out.

As described above, the managed terminal 40 is forcibly logged out only when a log-out request to log the managed terminal 40 out is issued from the managing user. However, it is desirable that, at the time or as early as possible from the time when the managed terminal 40 moves away from the managing terminal 30 by the predetermined distance or more, the managed terminal 40 be forcibly logged out.

Thus, for example, when receiving the forced log-out instruction described above from the managing user, the managing terminal 30 may periodically acquire installation location information from the beacon 6 and transmit a log-out request (step 322) to the authentication server 10 until the forced log-out instruction is canceled. Alternatively, when the log-out request is transmitted from the managing terminal 30 (step 322), the authentication server 10 may monitor whether or not the managed user has moved away from the managing user by the predetermined distance or more until a cancellation instruction is transmitted from the managing terminal 30 or until the managing terminal 30 is logged out and, when a managed user who has moved away from the managing user by the predetermined distance or more is found, may cause the managed terminal 40 to be forcibly logged out. As described above, after receiving the log-out request to log the managed terminal 40 out (step 322), the authentication server 10 may be able to specify the managed terminal 40 that has moved away from the managing terminal 30 by the predetermined distance or more as a log-out target and cause the managed terminal 40 to be forcibly logged out.

In the description provided above, it is assumed that a managed user moves away from a managing user. However, a managing user may move away from a managed user by a predetermined distance or more. In the second exemplary embodiment, in the case where a managing user moves away from a managed user and the managing user is thus not able to keep an eye on the managed user, the managed terminal 40 is caused to be logged out.

As described above, in the second exemplary embodiment, the beacon 6 is installed in the room 1, and the location relationship between the managing terminal 30 and the managed terminal 40 is determined by identifying the installation location of the beacon 6 as the current locations of the managing terminal 30 and the managed terminal 40, more strictly, by identifying the room 1 in which the managing terminal 30 and the managed terminal 40 are present.

However, for example, in the case where the managing terminal 30 and the managed terminal 40 each have a light detection and ranging (LiDAR) scanner function, the LiDAR scanner function may be used. The “LiDAR scanner function” is a function for measuring the distance to an object using laser light. Thus, a user measures, using the LiDAR scanner function, the distance to the vicinity of the user, that is, the distance to an object such as an inner wall, a shelf, or furniture in the room 1. Information for identifying the inner shape of the room 1 obtained by this measurement is space information unique to the room 1 and indicating characteristics of the room 1 as a space. As the map information in the room information table illustrated in FIG. 7, information for identifying the inner shape of the room 1 is set.

Thus, when space information obtained using the LiDAR scanner function is transmitted as location information from each of the managing terminal 30 and the managed terminal 40, the location relationship determining part 113 may refer to the map information indicating the space information acquired from each of the managing terminal 30 and the managed terminal 40 based on image analysis and set in the room information table to identify the room 1 in which the managing terminal 30 and the managed terminal 40 are present.

Furthermore, in the case where the managing terminal 30 and the managed terminal 40 each have a camera function, it may also be determined whether or not the managing terminal 30 and the managed terminal 40 are being used in the room 1, as with the LiDAR scanner function. In this case, images captured by cameras serve as information indicating the current locations of the managing terminal 30 and the managed terminal 40 and are transmitted to the authentication server 10 as location information. In this case, captured images of the inner appearance of the room 1 are set as the map information in the room information table illustrated in FIG. 7.

### Third Exemplary Embodiment

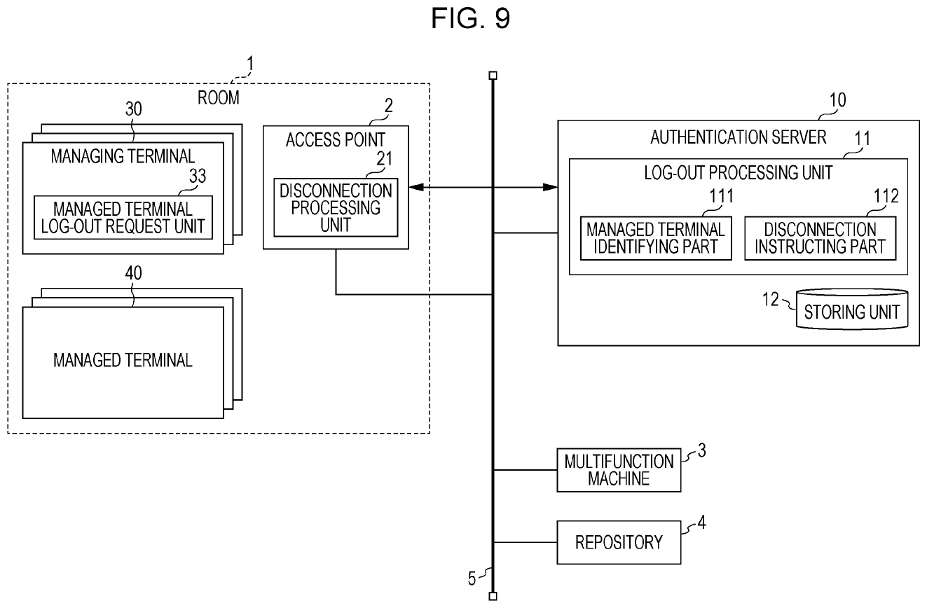

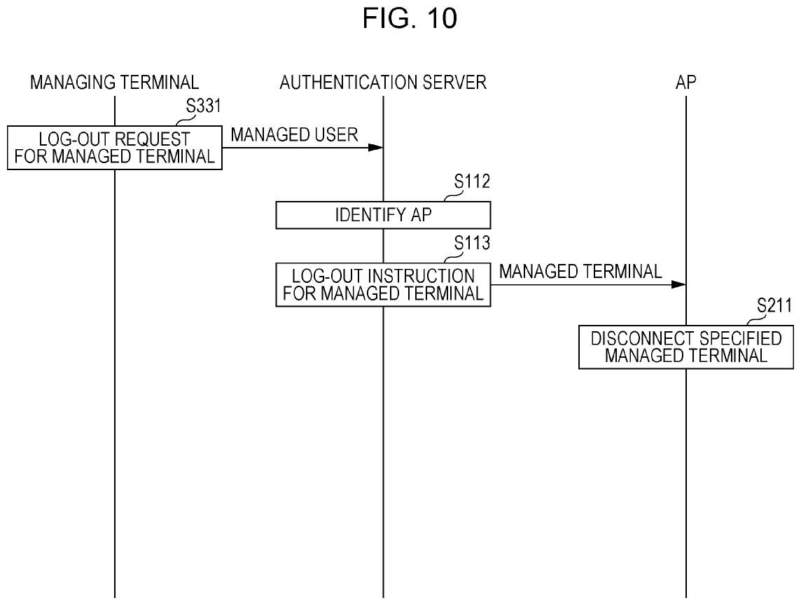

FIG. 9 is a block configuration diagram illustrating an authentication system in a third exemplary embodiment. The same components as those of the authentication system in the first exemplary embodiment illustrated in FIG. 1 are denoted by the same reference signs and explanation for those components will be omitted in an appropriate manner. As in the second exemplary embodiment, the managing terminal 30 includes the managed terminal log-out request unit 33 that requests the authentication server 10 to log the managed terminal 40 that is being managed by the managing terminal 30 out in the third exemplary embodiment. Although the managed terminal 40 that is being used by a managed user who is away from a managing user by a predetermined distance or more is caused to be logged out in the second exemplary embodiment, the managing user explicitly specifies the managed terminal 40 and causes the specified managed terminal 40 to be logged out in the third exemplary embodiment. A process for the case where a managing user causes the managed terminal 40 to be logged out of the internal system will be described with reference to a sequence diagram illustrated in FIG. 10. The same processing operations as those in the first and second exemplary embodiments will be denoted by the same step numbers and explanation for those processing operations will be omitted in an appropriate manner.

After specifying the managed terminal 40 to be logged out on a predetermined log-out request screen displayed on the screen of the managing terminal 30, the managing user performs a predetermined log-out request operation for the managed terminal 40. In response to the user operation, the managed terminal log-out request unit 33 transmits a log-out request including information on the specified managed terminal 40 to the authentication server 10 (step 331). Strictly speaking, the managed terminal log-out request unit 33 transmits a terminal ID for identifying the managed terminal 40. As in the third exemplary embodiment, description of transmitting identification information will be omitted in the description provided below.

To specify a managed terminal 40 as a log-out target, the managing terminal 30 may make an inquiry to the authentication server 10, in response to an instruction from the managing user, to acquire the list of managed terminals 40 that are being managed by the managing terminal 30 and display the list on the log-out request screen. Accordingly, the managing user is able to specify the managed terminal 40 by a selection operation.

When receiving the log-out request, the managed terminal identifying part 111 of the authentication server 10 refers to the connected terminal table to identify the access point 2 to which the managed terminal 40 specified by the managing user is being connected (step 112).

The validity of the managed terminal 40 specified by the managing user may be confirmed in advance. That is, it may be confirmed in advance whether or not the managing terminal 30 from which the log-out request has been issued is managing the specified managed terminal 40. Furthermore, the managing user may specify a managed user instead of the managed terminal 40.

Then, the disconnection instructing part 112 instructs the access point 2 identified by the managed terminal identifying part 111 to disconnect the managed terminal 40 specified by the managing user (step 113).

The disconnection processing unit 21 of the access point 2 disconnects the specified managed terminal 40 (step 211). Accordingly, the managed terminal 40 specified by the managing user is disconnected from the access point 2 and is thus forcibly logged out of the internal system.

According to the third exemplary embodiment, by explicitly specifying the managed terminal 40 to be logged out, the managed terminal 40 may be able to be forcibly logged out.

### Fourth Exemplary Embodiment

In the third exemplary embodiment, a managing user explicitly specifies a managed terminal 40 to be logged out. If a managing user wants to cause all the managed users that are being managed by the managing user to be logged out, the managing user needs to specify all the managed terminals 40 individually. In the case where there are a large number of managed users being managed, it is troublesome to specify all the managed users individually. Thus, in a fourth exemplary embodiment, a state in which a managing user does not specify any managed user to be logged out is regarded as specifying all the managed users, and a log-out request to log the managed terminals 40 out is transmitted.

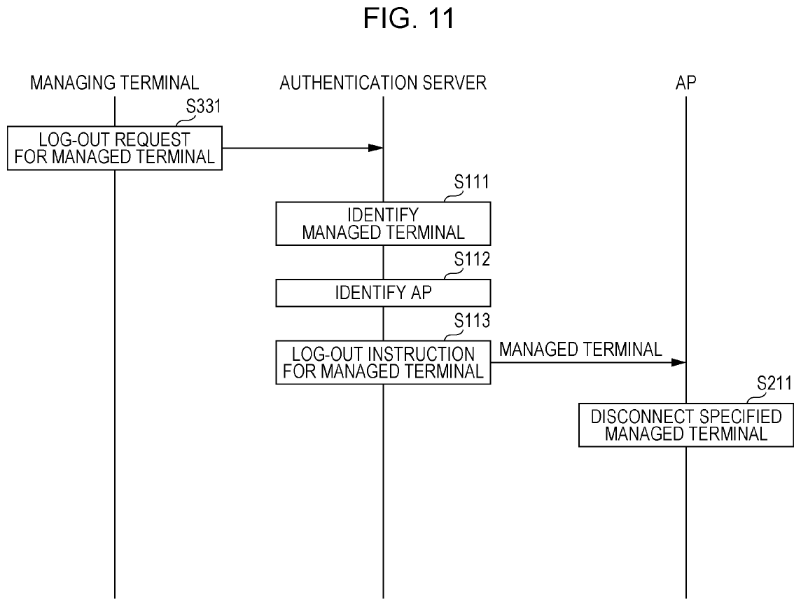

In the fourth exemplary embodiment, a process for the case where a managing user causes a managed terminal 40 to be logged out of the internal system will be described with reference to a sequence diagram of FIG. 11. The same processing operations as those in the foregoing exemplary embodiments will be denoted by the same step numbers and explanation for those processing operations will be omitted in an appropriate manner.

The managing user performs, on a predetermined log-out request screen displayed on the screen of the managing terminal 30, a predetermined log-out request operation for a managed terminal 40, without specifying the managed terminal 40 to be logged out. In response to the user operation, the managed terminal log-out request unit 33 transmits to the authentication server 10 a log-out request not including specification of a managed terminal 40 (step 331).

In the case where the received log-out request does not include specification of a managed terminal 40, the managed terminal identifying part 111 of the authentication server 10 regards the log-out request specifies all the managed terminals 40 that are being managed by the managing user as log-out targets. Then, the managed terminal identifying part 111 refers to the connected terminal table to identify all the managed terminals 40 that are being managed by the managing user (step 111) and identify access points 2 to which the managed terminals 40 are being connected (step 112).

Then, the disconnection instructing part 112 instructs the access points 2 specified by the managed terminal identifying part 111 to disconnect all the managed terminals 40 implicitly specified by the managing user (step 113).

The disconnection processing unit 21 of each of the access points 2 disconnects the specified managed terminal 40 (step 211). Accordingly, the managed terminals 40 implicitly specified by the managing user are disconnected from the access points 2 and are thus forcibly logged out of the internal system.

According to the fourth exemplary embodiment, in the case where a log-out request to log a managed terminal 40 out does not include specification of a managed terminal 40, the authentication server 10 may regard all the managed terminals 40 that are being managed by the managing terminal 30 as being specified as log-out targets and cause all the managed terminals 40 that are being managed by the managing terminal 30 to be forcibly logged out.

### Fifth Exemplary Embodiment

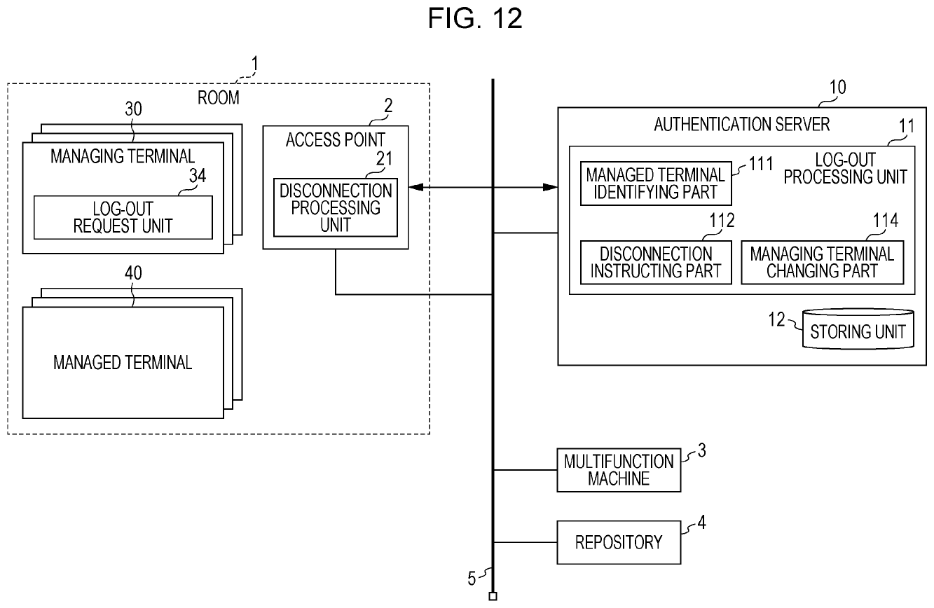

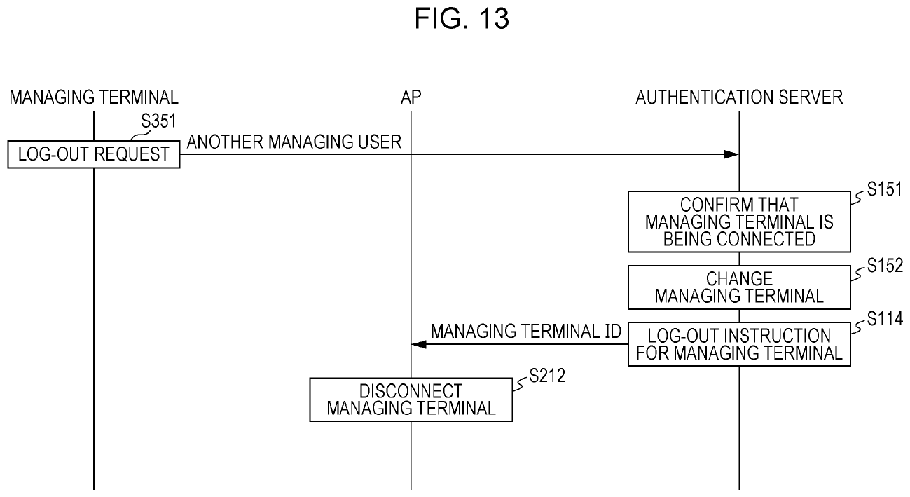

FIG. 12 is a block configuration diagram of an authentication system according to a fifth exemplary embodiment. The same components as those of the authentication system in the first exemplary embodiment illustrated in FIG. 1 are denoted by the same reference signs and explanation for those components will be omitted in an appropriate manner.

The log-out processing unit 11 of the authentication server 10 includes a managing terminal changing part 114, in addition to the configuration according to the first exemplary embodiment. In the case where a log-out request transmitted from the managing terminal 30 specifies another managing user, the managing terminal changing part 114 delegates management of a managed user by changing a user managing a managed user from the managing user who has issued the log-out request to another managing user.

In the first exemplary embodiment described above, at the time when a managing user logs out, a managed user who is being managed by the managing user is forcibly logged out, so that absence of a user who manages the managed terminal 40 is avoided. In other words, if a user who manages the managed terminal 40 is not absent, the managed user might not need to be forcibly logged out.

Thus, in the fifth exemplary embodiment, in the case where another managing user is available to manage the managed user who has been managed by the original managing user, the other managing user is delegated to manage the managed user. Thus, even if the original managing user is logged out, the managed user does not need to be logged out.

Hereinafter, a process for the case where a managing user logs out of the internal system will be described with reference to a sequence diagram illustrated in FIG. 13. The same processing operations as those in the foregoing exemplary embodiments will be denoted by the same step numbers and explanation for those processing operations will be omitted in an appropriate manner.

A managing user specifies, on a predetermined log-out request screen displayed on the screen of the managing terminal 30, a delegated managing user who will be delegated to manage a managed user, and then performs a log-out request operation for a managed terminal 40. The managing user may specify a user ID of a delegated managing user or may specify a terminal ID of a managing terminal 30 used by a delegated managing user. In response to the user operation, the managed terminal log-out request unit 33 transmits to the authentication server 10 a log-out request including information on the specified managed user (step 331).

When the authentication server 10 receives the log-out request transmitted from the managing terminal 30, if the log-out request includes specification of a delegated managing user, the authentication server 10 determines that the log-out request also serves as a managing user change request. In the case where a specified managing user is different from a managing user from which the request has been transmitted, the authentication server 10 may determine that the log-out request also serves as a managing user change request. In this case, by referring to the connected terminal table in which the managing terminal 30 that is being used by the managing user specified in the log-out request is registered, the managing terminal changing part 114 confirms that the corresponding managing terminal 30 is being connected to the internal system (step 151). Then, the managing terminal changing part 114 changes setting in the connected terminal table such that information on the managed terminal associated with the managing terminal 30 from which the log-out request has been issued becomes associated with the delegated managing user (step 152).

Then, the disconnection instructing part 112 instructs the access point 2 to disconnect the managing terminal 30 from which the log-out request has been issued (step 114). In response to the instruction, the disconnection processing unit 21 of the access point 2 disconnects the managing terminal 30 and thus logs the managing terminal 30 out (step 212).

In the first exemplary embodiment, when a managing terminal 30 logs out, a managed terminal 40 that is being managed by the managing terminal 30 is also caused to be logged out. In the fifth exemplary embodiment, however, another managing terminal 30 is available to manage the managed terminal 40. Thus, the managed terminal 40 does not need to be logged out when the managing terminal 30 logs out.

Accordingly, for example, according to the first exemplary embodiment, in the case where a managed user (for example, a managed user Y) collaboratively works with multiple managing users (for example, managing users A and B), when the managed user Y arrives, the managing user A applies to the authentication system for managing the managed user Y. When the managing user A needs to be disconnected from the internal system, for example, by leaving the room, the managed user Y is forced to be logged out. If the managed user Y wants to continue the collaborative work with the managing user B, application to the authentication system is required again so that the managed user Y will be managed by the managing user B. In contrast, in the fifth exemplary embodiment, setting of the connected terminal table used for management of association between a managing user and a managed user is changed such that the managed user Y will be managed by the managing user B. Thus, the managed user Y is able to avoid being logged out. Furthermore, the managing user is able to avoid conducting troublesome application again.

In the description provided above, by causing a log-out request from a managing user to include specification of another managing user, the log-out request also serves as a managing user change request. However, by performing a predetermined operation on a managing terminal 30, a managing user may transmit to the authentication server 10 a managing user change request including specification of another managing user. In this case, a managing user is able to delegate management of a managed user to another managing user without logging out.

Furthermore, in the case where a managing user manages multiple managed users, by causing a managing user change request to include specification of a managed user for which management will be delegated to another managing user, management of a desired managed user may be selectively delegated. In the case where a log-out request also serving as a managing user change request is transmitted to the authentication server 10, a managed user who is not specified in the log-out request among managed users managed by the managing user is forcibly logged out.

Furthermore, in the fifth exemplary embodiment, a managed user specifies in advance a delegated managing user to whom management of a managed user will be delegated. However, in the case where the condition is such that the managing terminal 30 that is used by the delegated managing user needs to be connected to the internal system, the managing user may make an inquiry to the authentication server 10 to acquire the list of managing users being connected to the internal system and specify a delegated managing user from the list.

In each of the foregoing exemplary embodiments, a process for logging out the managed terminal 40 has been described. However, the exemplary embodiments may be combined in an appropriate manner without contradiction.

Furthermore, in each of the foregoing exemplary embodiments, a case where an authentication system is incorporated in an internal system of a company has been described as an example. However, the present disclosure is not limited to this. The authentication system may also be applied to a facility where a collaborative work is performed among multiple users.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
in a case where a managed terminal being used by a managed user who is not permitted to log into a network system has been logged in the network system under management by a managing user who is permitted to log into the network system, specify a managed terminal to be logged out from among managed terminals being used by managed users under management by the managing user, in accordance with a predetermined operation performed by the managing user; and
cause the specified managed terminal to be logged out of the network system.

2. The information processing apparatus according to claim 1, wherein the predetermined operation is an operation for issuing a log-out request to log the managing terminal being used by the managing user out of the network system.

3. The information processing apparatus according to claim 2, wherein the processor is configured to, in a case where a delegated managing user is specified in the log-out request, avoid the managed terminal that is being used by the managed user who has been under management by the managing user who is to log out being logged out, by changing a user managing the managed user from the managing user who is to log out to the delegated managing user.

4. The information processing apparatus according to claim 1,
wherein the predetermined operation is an operation for issuing a log-out request including specification of location information about the managing terminal being used by the managing user, and
wherein the processor is configured to, in response to the log-out request, specify a managed terminal that is away from the managing terminal by a predetermined distance or more as a log-out target.

5. The information processing apparatus according to claim 4, wherein the processor is configured to, after receiving the log-out request, specify the managed terminal that is away from the managing terminal by the predetermined distance or more as a log-out target.

6. The information processing apparatus according to claim 1, wherein the managed terminal to be logged out is specified by the managing user.

7. The information processing apparatus according to claim 6,
wherein the predetermined operation is an operation for issuing a log-out request to log the managed terminal out, and
wherein the processor is configured to, in a case where the log-out request includes specification of a managed terminal, identify the specified managed terminal as a log-out target.

8. The information processing apparatus according to claim 6,
wherein the predetermined operation is an operation for issuing a log-out request to log the managed terminal out, and
wherein the processor is configured to, in a case where the log-out request does not include specification of a managed terminal, identify managed terminals being used by all the managed users under management by the managing user as log-out targets.

9. The information processing apparatus according to claim 1,
wherein the predetermined operation is an operation for issuing a managing user change request including specification of a delegated managing user, and
wherein the processor is configured to, in response to the managing user change request, delegate management of the managed user who has been under management by the managing user to the delegated managing user.

10. An information processing method comprising:
in a case where a managed terminal being used by a managed user who is not permitted to log into a network system has been logged in the network system under management by a managing user who is permitted to log into the network system, specifying a managed terminal to be logged out from among managed terminals being used by managed users under management by the managing user, in accordance with a predetermined operation performed by the managing user; and
causing the specified managed terminal to be logged out of the network system.

11. A non-transitory computer readable medium storing a program causing a computer to execute a process comprising:
in a case where a managed terminal being used by a managed user who is not permitted to log into a network system has been logged in the network system under management by a managing user who is permitted to log into the network system, specifying a managed terminal to be logged out from among managed terminals being used by managed users under management by the managing user, in accordance with a predetermined operation performed by the managing user; and
causing the specified managed terminal to be logged out of the network system.
